(19) United States
(12) Patent Application Publication
(10) Pub. No.: US 2025/0004437 A1
(43) Pub. Date: Jan. 2, 2025

(54) Low Code Engineering Function Orchestrator

(71) Applicant: Siemens Aktiengesellschaft, Munich (DE)

(72) Inventors: Yufeng Li, Wynnewood, PA (US); Patrick Eisen, Princeton, NJ (US); Gustavo Arturo Quiros Araya, Orange, CT (US)

(73) Assignee: Siemens Aktiengesellschaft, Munich (DE)

(21) Appl. No.: 18/682,003

(22) PCT Filed: Aug. 31, 2021
(86) PCT No.: PCT/US2021/048340

§ 371 Date: Feb. 7, 2024

(51) Int. Cl. G05B 19/042

(52) U.S. Cl. CPC G05B 19/0426; G05B 2219/31104; G05B 2219/32136; G05B 2219/34256

(57) ABSTRACT

An industrial system includes a plurality of machines that define respective hardware and automation functions associated with the hardware. The industrial system further includes an engineering module hosted within the industrial system, and an application programming interface (API) communicatively coupled to the engineering module. The industrial system can further include a web application communicatively coupled to the engineering module via the API. A computing device can be configured to access the engineering module via the web application and the API, and the engineering module can be configured to configure the plurality of machines based on instructions received by the web application.

### BACKGROUND

Industrial automation systems can be used to control the operation of machines and other components in a systematic manner. Automation systems can include various automation domains such as factory automation, process automation, building automation, energy automation, and the like. Automation systems can also include equipment from multiple vendors. In some cases, equipment and machines within an automation system may use varying mechanisms associated with their respective ecosystems, such as varying runtime environments, protocols, and programming languages (e.g., vendor-specific programming languages).

Today's automation systems are often hard-wired, such that hardware (e.g., production machines, robots, CNC machines) is bound with software in a particular configuration at an engineering phase. For example, industrial automation systems today often consist of hardware devices with general-purpose firmware (system software) that is configured for a specific task at hand. Operators, in turn, typically work with such an automation system on a day-to-day basis to change parameter settings and execute system functions. As a result, today's automation systems often lack flexibility to adapt to changes in a given plant, machine, or production process. In particular, such changes typically require an automation engineer because operators do not have the ability to reconfigure or reprogram the system. In some current engineering applications, engineering functionalities can be accessed via programming using application programming interfaces (APIs). It is recognized herein, however, that such APIs can limit access to specific skilled users and/or specific computing devices from particular domains.

### BRIEF SUMMARY

Embodiments of the invention address and overcome one or more of the described-herein shortcomings or technical problems by providing methods, systems, and apparatuses for generating automation system configurations from a low code web-based platform that can be hosted on a variety of devices.

In an example aspect, an industrial system includes a plurality of machines that define respective hardware and automation functions associated with the hardware. The industrial system further includes an engineering module hosted within the industrial system, and an application programming interface (API) communicatively coupled to the engineering module or application. The industrial system can further include a web application communicatively coupled to the engineering module via the API. A computing device can be configured to access the engineering module via the web application and the API, and the engineering module can be configured to configure the plurality of machines based on instructions received by the web application. The API can be configured to, based on the instructions, obtain a plurality of templates associated with a project. The web application can be configured to display the plurality of templates via the computing device. The web application can be further configured to receive selections associated with the plurality of templates, and based on the selections, configure the plurality of machines to perform the project. In another example aspect, the engineering module is further configured to, responsive to user actuations on the computing device, implement a test on the plurality of machines performing the project.

The web application can also display status information associated with the industrial system, such that the industrial system can be monitored and controlled from the computing device. In some cases, the computing device defines a mobile computing device that is unassociated with the industrial system. The web application can also display user options on the computing device, wherein the user options defining a low code industrial engineering platform.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an example automation system that includes a control module, in accordance with an example embodiment.

FIG. 2 is a block diagram that illustrates another example automation system and messages that are transmitted within the automation system, in accordance with an example embodiment.

FIG. 3 shows an example of a computing environment within which embodiments of the disclosure may be implemented.

### DETAILED DESCRIPTION

As an initial matter, it is recognized herein that current engineering applications for industrial automation systems typically require a user interface (UI) for access. Some applications, such as a total integrated automation (TIA) Portal, can enable users to access engineering applications without a user interface, for instance via application programming interfaces (APIs). It is recognized herein, however, that APIs often require users to have deep knowledge of the engineering application or software itself, thereby limiting or preventing some users (e.g., non-developers from different domains) from accessing the engineering application or software. For examples, users may need to write a program to import data to (or output data from) an industrial engineering application via the TIA portal or the like. It is further recognized herein that, in some cases, even if a particular user has the ability to program via a given API, local access rights are often limited to a particular computing device or particular domain, thereby also preventing users of various computing devices from accessing the engineering application or software.

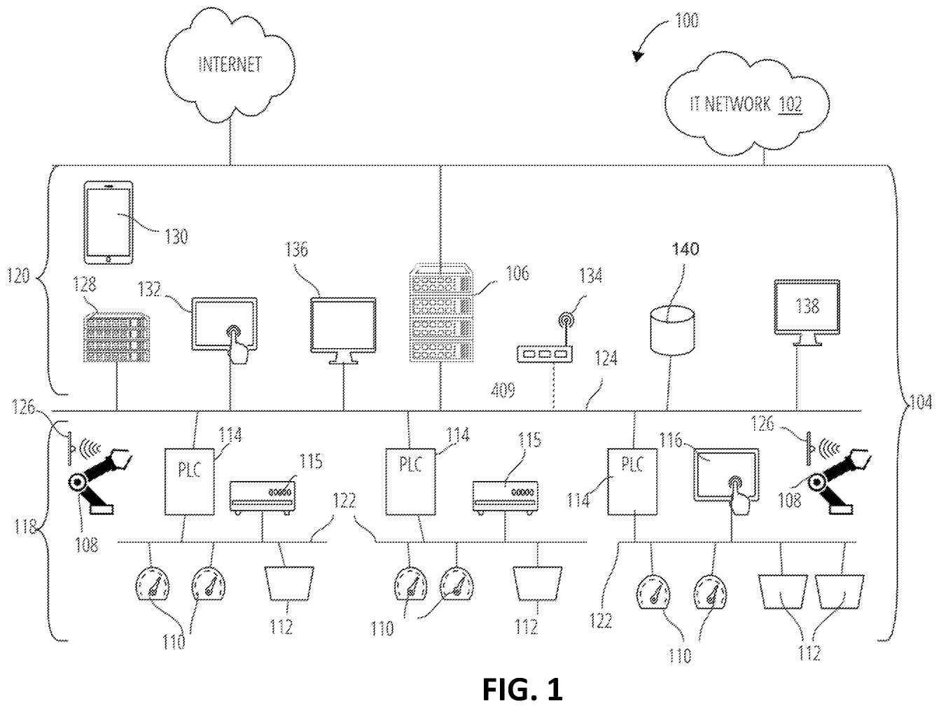

Referring initially to FIG. 1, an example automation system 100 includes multiple subsystems that contain control logic, host web servers, and the like. For example, the automation system can include an office or corporate IT network 102 and an operational plant or production network 104 communicatively coupled to the IT network 102. The production network 104 can include one or more engineering modules 106 throughout the production network 104. An example engineering module 106 is connected to the IT network 102. The arrangement of engineering modules 106 can vary as desired, and all such arrangements are contemplated as being within the scope of this disclosure. For example, the engineering module 106 can define software that runs on components within the production network 104. The production network 104 can include various production machines configured to work together to perform one or more manufacturing operations. Example production machines of the production network 104 can include, without limitation, robots 108 and other field devices that can be controlled by a respective PLC 114, such as sensors 110, actuators 112, or other machines, such as automatic guided vehicles (AGVs). In various examples, a given AGV defines the control module 106. The PLC 114 can send instructions to respective field devices. In some cases, a given PLC 114 can be coupled to a human machine interfaces (HMIs) 116. It will be understood that the automation system 100 is simplified for purposes of example. That is, the automation system 100 may include additional or alternative nodes or systems, for instance other network devices, that define alternative configurations, and all such configurations are contemplated as being within the scope of this disclosure.

The automation system 100, in particular the production network 104, can define a fieldbus portion 118 and an Ethernet portion 120. For example, and without limitation, the fieldbus portion 118 can include the robots 108, PLC 114, sensors 110, actuators 112, HMIs 116, and AGVs. The fieldbus portion 118 can define one or more production lines or control zones. The PLC 114, sensors 110, actuators 112, and HMI 116 within a given production line can communicate with each other via a respective field bus 122. Each control zone can be defined by a respective PLC 114, such that the PLC 114, and thus the corresponding control zone, can connect to the Ethernet portion 120 via an Ethernet connection 124. The robots 108 and AGVs can be configured to communicate with other devices within the fieldbus portion 118 via a Wi-Fi connection 126. Similarly, the robots 108 and AGVs can communicate with the Ethernet portion 120, in particular a Supervisory Control and Data Acquisition (SCADA) server 128, via the Wi-Fi connection 126. The Ethernet portion 120 of the production network 104 can include various computing devices or subsystems communicatively coupled together via the Ethernet connection 124. Example computing devices or subsystems in the Ethernet portion 120 include, without limitation, a mobile data collector 130, HMIs 132, the SCADA server 128, the control unit 106, a wireless router 134, a manufacturing execution system (MES) 136, an engineering system (ES) 138, and a log server 140. The ES 138 can include one or more engineering works stations. In an example, the MES 136, HMIs 132, ES 138, and log server 140 are connected to the production network 104 directly. The wireless router 134 can also connect to the production network 104 directly. Thus, in some cases, mobile users, for instance the mobile data collector 130 and robots 108 (e.g., AGVs), can connect to the production network 104 via the wireless router 134.

Example users of the automation system 100 include, for example and without limitation, operators of an industrial plant or engineers that can update the control logic of a plant. By way an example, an operator can interact with the HMIs 132, which may be located in a control room of a given plant. Alternatively, or additionally, an operator can interact with HMIs of the system 100 that are located remotely from the production network 104. Similarly, for example, engineers can use the HMIs 116 that can be located in an engineering room of the automation system 100. Alternatively, or additionally, an engineer can interact with HMIs of the automation 100 that are located remotely from the production network 104.

The engineering phase of automation system implementation typically consists of programming and configuration. By way of example, programming generally includes the development of the logic of the system (e.g., conditions) and configuration generally includes the adjustment of parameters of the system. It is recognized herein that programming and configuration are tightly coupled in today's automation system implementations. By way of example, Siemens Totally Integrated Automation (TIA) Portal projects typically begin with hardware configuration that is followed by programming. In some cases, the engineered design is refined via iterations of changing the configuration or programming and evaluating the effects on the other of the configuration or programming. Further, it is recognized herein that existing automation engineering approaches typically hardcode the software to the hardware, which can force the iterative process for engineering described above. It is further recognized herein that, in existing approaches, changes during runtime can also force further iterations and refinements of engineering (or re-engineering).

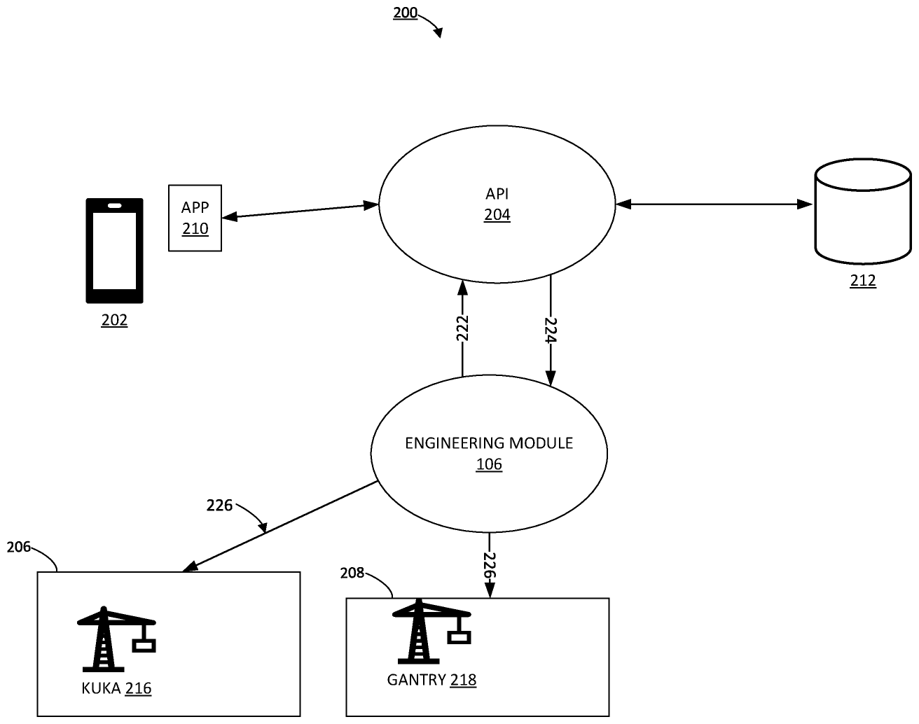

Referring also to FIG. 2, in accordance with various embodiments described herein, programming and configuration of industrial automation systems, for instance an industrial automation system 200, can be performed via a web application 210 accessible from a computing device 202, for instance a mobile phone, tablet, wearable device, desktop computer, or the like. Engineering an industrial automation system typically includes various tasks, such as programming (implementing) automation functions, configuring the system, testing the system, commissioning the system, and maintaining the system. Implementing automation functions can include programming automation functionality for specific hardware. In accordance with various embodiments, functional level APIs, for instance an API 204, can be communicatively coupled with a low code platform (e.g., Mendix) defined by the web application 210, that engineering functionalities of the system 200 are flexible and customizable, for instance by a user (e.g., engineer or operator) of the computing device 202. In particular, local functionalities of a first subsystem 206 and a second subsystem 208 of the industrial system 200 can be made available to a plurality of users via the web application 210, such that users can customize the subsystems 206 and 208 for different scenarios, for instance for deployment, monitoring, and testing. The API 204 can define a functional level so as limit communication trips to the engineering module 106. Furthermore, non-developers can use the web application 210, as the web application 210 can define a low code platform.

Still referring to FIG. 2, automation systems, for instance the industrial automation system 200 can include the API 204 configured to receive and process messages, for instance from the web application 210. The system 200 can further include the engineering module 106 that can be configured to execute actions, for instance based on instructions received from the computing device 202 via the web application 210. In particular, based on instructions or user selections, the engineering module 106 perform actions, such as, for example and without limitation, selecting automation functions, selecting settings, selecting or adjusting return values, or the like.

The industrial automation system 200 can include various subsystems and devices, for instance a plurality of machines, configured to perform various automaton functions. The plurality of machines can define respective hardware and automation functions associated with the hardware. For example, the automation system can include the first subsystem 206 and the second subsystem 208 that be configured to produce a product or outcome. In some examples, the system 200 also can include a database or repository, for instance a database 212, configured to store templates associated with various projects. By way of example, the automation system 200 can include a production line that can be configured to produce multiple products, such that multiple products can share the production line. The production line can perform a skill-based production process. For example, the production line, in particular the first subsystem 206, can define a Kuka station 216 configured to pick production parts. The production line, in particular the second subsystem 208, can define a gantry station 218 configured to pick production parts.

It should be appreciated that functionality described as being supported by program modules of the automation system 200 may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules. Thus, it will be also understood that the automation system 200 is simplified to illustrate an example, and the automation system 200 can vary as desired, and all such automation systems are contemplated as being within the scope of this disclosure.

With continuing reference to FIG. 2, in accordance with an example, at 224, the engineering module 106 receives messages (e.g., instructions or user selections) from consumers of services or skills, for instance from the application 210 via the API 204. The engineering module 106 can be hosted within the industrial system 200, and the application programming interface (API) 204 can be communicatively coupled to the engineering module 106. The industrial system 200 can further include the web application 210 communicatively coupled to the engineering module 106 via the API 204. The computing device 202 can be configured to access the engineering module 106 via the web application 210 and the API 204, and the engineering module 106 can be configured to configure the plurality of machines (e.g., KUKA 216 and gantry 218) based on instructions received by the web application 210. The API 204 can, based on the instructions, obtain a plurality of templates associated with a project, for instance from the database 212. The web application 210 can be configured to display, for instance to a user, the plurality of templates via the computing device 202. The web application 210 can be further configured to receive selections associated with the plurality of templates, and based on the selections, configure the plurality of machines to perform the project.

In another example aspect, the engineering module 106 can, responsive to user actuations on the computing device 202, implement a test on the plurality of machines performing the project. The web application 210 can also display status information associated with the industrial system 200, such that the industrial system can be monitored from the computing device 202. In some cases, the computing device 202 defines a mobile computing device that is unassociated with the industrial system 200. The web application 210 can also display user options on the computing device 202, wherein the user options defining a low code industrial engineering platform.

At 226, the engineering module 106 can trigger the first machine (e.g., Kuka 216, gantry 218) to perform an automation skill. At 222, the engineering module can send information associated with monitoring the subsystems 206 and 208, to the application 210 via the API 204.

Thus, as described above, in accordance with various embodiments, an industrial system includes a plurality of machines that define respective hardware and automation functions associated with the hardware. The industrial system further includes an engineering module hosted within the industrial system, and an application programming interface (API) communicatively coupled to the engineering module or application. The industrial system can further include a web application communicatively coupled to the engineering module via the API. A computing device can be configured to access the engineering module via the web application and the API, and the engineering module can be configured to configure the plurality of machines based on instructions received by the web application. The API can be configured to, based on the instructions, obtain a plurality of templates associated with a project. The web application can be configured to display the plurality of templates via the computing device. The web application can be further configured to receive selections associated with the plurality of templates, and based on the selections, configure the plurality of machines to perform the project. In another example aspect, the engineering module is further configured to, responsive to user actuations on the computing device, implement a test on the plurality of machines performing the project.

The web application can also display status information associated with the industrial system, such that the industrial system can be monitored and controlled from the computing device. In some cases, the computing device defines a mobile computing device that is unassociated with the industrial system. The web application can also display user options on the computing device, wherein the user options defining a low code industrial engineering platform.

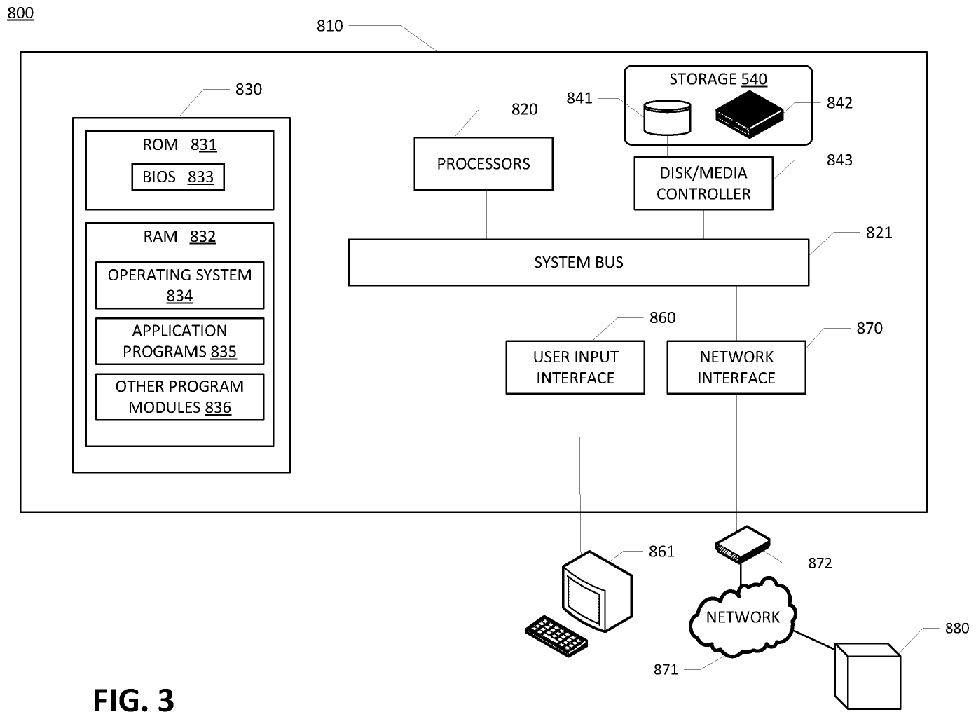

FIG. 3 illustrates an example of a computing environment within which embodiments of the present disclosure may be implemented. A computing environment 800 includes a computer system 810 that may include a communication mechanism such as a system bus 821 or other communication mechanism for communicating information within the computer system 810. The computer system 810 further includes one or more processors 820 coupled with the system bus 821 for processing the information. The industrial systems 100 and 200, in particular the engineering module 106, may include, or be coupled to, the one or more processors 820.

The processors 820 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 820 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 821 may include at least one of a system bus, a memory bus, an address bus, or a message bus, and may permit exchange of information (e.g., data (including computer-executable code), signaling, etc.) between various components of the computer system 810. The system bus 821 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 4, the computer system 810 may also include a system memory 830 coupled to the system bus 821 for storing information and instructions to be executed by processors 820. The system memory 830 may include computer readable storage media in the form of volatile and/or nonvolatile memory, such as read only memory (ROM) 831 and/or random access memory (RAM) 832. The RAM 832 may include other dynamic storage device(s) (e.g., dynamic RAM, static RAM, and synchronous DRAM). The ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in the ROM 831. RAM 832 may contain data and/or program modules that are immediately accessible to and/or presently being operated on by the processors 820. System memory 830 may additionally include, for example, operating system 834, application programs 835, and other program modules 836. Application programs 835 may also include a user portal for development of the application program, allowing input parameters to be entered and modified as necessary. The operating system 834 may be loaded into the memory 830 and may provide an interface between other application software executing on the computer system 810 and hardware resources of the computer system 810. More specifically, the operating system 834 may include a set of computer-executable instructions for managing hardware resources of the computer system 810 and for providing common services to other application programs (e.g., managing memory allocation among various application programs). In certain example embodiments, the operating system 834 may control execution of one or more of the program modules depicted as being stored in the data storage 840. The operating system 834 may include any operating system now known or which may be developed in the future including, but not limited to, any server operating system, any mainframe operating system, or any other proprietary or non-proprietary operating system.

The computer system 810 may also include a disk/media controller 843 coupled to the system bus 821 to control one or more storage devices for storing information and instructions, such as a magnetic hard disk 841 and/or a removable media drive 842 (e.g., floppy disk drive, compact disc drive, tape drive, flash drive, and/or solid state drive). Storage devices 840 may be added to the computer system 810 using an appropriate device interface (e.g., a small computer system interface (SCSI), integrated device electronics (IDE), Universal Serial Bus (USB), or FireWire). Storage devices 841, 842 may be external to the computer system 810.

The computer system 810 may also include a field device interface 865 coupled to the system bus 821 to control a field device 866, such as a device used in a production line.

The computer system 810 may include a user input interface or GUI 861, which may comprise one or more input devices, such as a keyboard, touchscreen, tablet and/or a pointing device, for interacting with a computer user and providing information to the processors 820.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium of storage 840, such as the magnetic hard disk 841 or the removable media drive 842. The magnetic hard disk 841 and/or removable media drive 842 may contain one or more data stores and data files used by embodiments of the present disclosure. The data store 840) may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 800 may further include the computer system 810 operating in a networked environment using logical connections to one or more remote computers, such as remote computing device 880. The network interface 870 may enable communication, for example, with other remote devices 880 or systems and/or the storage devices 841, 842 via the network 871. Remote computing device 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing device 880). The network 871 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

It should be appreciated that the program modules, applications, computer-executable instructions, code, or the like depicted in FIG. 4 as being stored in the system memory 830 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 810, the remote device 880, and/or hosted on other computing device(s) accessible via one or more of the network(s) 871, may be provided to support functionality provided by the program modules, applications, or computer-executable code depicted in the figures and/or additional or alternate functionality. Further, functionality may be modularized differently such that processing described as being supported collectively by the collection of program modules depicted in the figures may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in the figures may be implemented, at least partially, in hardware and/or firmware across any number of devices.

It should further be appreciated that the computer system 810 may include alternate and/or additional hardware, software, or firmware components beyond those described or depicted without departing from the scope of the disclosure. More particularly, it should be appreciated that software, firmware, or hardware components depicted as forming part of the computer system 810 are merely illustrative and that some components may not be present or additional components may be provided in various embodiments. While various illustrative program modules have been depicted and described as software modules stored in system memory 830, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method performed within an industrial system that comprises a plurality of machines that define respective hardware and automation functions associated with the hardware, the method comprising:
a computing device accessing an engineering module via a web application and an application programming interface (API), the engineering module hosted within the industrial system; and
based on instructions received by the web application, the engineering module configuring the plurality of machines.

2. The method as recited in claim 1, the method further comprising:
based on the instructions, the API obtaining a plurality of templates associated with a project.

3. The method as recited in claim 2, the method further comprising:
the web application displaying the plurality of templates via the computing device.

4. The method as recited in claim 3, the method further comprising:
receiving selections associated with the plurality of templates; and
based on the selections, configuring the plurality of machines to perform the project.

5. The method as recited in claim 4, the method further comprising:
responsive to user actuations on the computing device, the engineering module implementing a test on the plurality of machines performing the project.

6. The method as recited in claim 1, the method further comprising:
the web application displaying status information associated with the industrial system, such that the industrial system can be monitored from the computing device.

7. The method as recited in claim 1, wherein the computing device defines a mobile computing device that is unassociated with the industrial system.

8. The method as recited in claim 1, the method further comprising:
the web application displaying user options on the computing device, the user options defining a low code industrial engineering platform.

9. An industrial system, the industrial system comprising:
a plurality of machines that define respective hardware and automation functions associated with the hardware;
an engineering module hosted within the industrial system;
an application programming interface (API) communicatively coupled to the engineering module; and
and a web application communicatively coupled to the engineering module via the API,
wherein a computing device is configured to access the engineering module via the web application and the API, and the engineering module is configured to configure the plurality of machines based on instructions received by the web application.

10. The industrial system as recited in claim 9, wherein the API is configured to, based on the instructions, obtain a plurality of templates associated with a project.

11. The industrial system as recited in claim 10, wherein the web application is configured to the display the plurality of templates via the computing device.

12. The industrial system as recited in claim 11, wherein the web application further configured to:
receive selections associated with the plurality of templates; and
based on the selections, configure the plurality of machines to perform the project.

13. The industrial system as recited in claim 12, wherein the engineering module is further configured to, responsive to user actuations on the computing device, implement a test on the plurality of machines performing the project.

14. The industrial system as recited in claim 9, wherein the web application is further configured to display status information associated with the industrial system, such that the industrial system can be monitored from the computing device.

15. The industrial system as recited in claim 9, wherein the computing device defines a mobile computing device that is unassociated with the industrial system.

16. The industrial system as recited in claim 9, wherein the web application is further configured to display user options on the computing device, the user options defining a low code industrial engineering platform.
